(19) United States
(12) Patent Application Publication
(10) Pub. No.: US 2021/0312875 A1
(43) Pub. Date: Oct. 7, 2021

(54) CONTROL OF LIGHT INTENSITIES BASED ON USE AND DECAY

(71) Applicant: Hewlett-Packard Development Company, L.P., Spring, TX (US)

(72) Inventors: Hsing-Hung Hsieh, Taipei City (TW); Cheng-Hua Yu, Taipei City (TW); Ann Alejandro Villegas, Spring, TX (US)

(73) Assignee: Hewlett-Packard Development Company, L.P., Spring, TX (US)

(21) Appl. No.: 17/042,158

(22) PCT Filed: Nov. 27, 2018
(86) PCT No.: PCT/US2018/062655

§ 371 Date: Sep. 27, 2020

(51) Int. Cl. G09G 3/34; G02F 1/13357

(52) U.S. Cl. CPC G09G 3/3406; G09G 2320/0233; G09G 2320/0646; G02F 1/133602

(57) ABSTRACT

A controller to control the light intensity of a first light source and a second light source based on a video signal of a video to be displayed on the display, the decay curve, and usage data regarding the first light source and second light source.

### BACKGROUND

Displays, such as those used in televisions, monitors, and cell phones, may be illuminated through the use of a light source, such as a backlight. To allow for better control of the light intensity, the display may be broken into sections that are illuminated by distinct light sources. Local dimming may allow one portion of the display to be illuminated brighter by one set of light sources while another portion of the screen is kept darker by operating a second set of light sources at a lower light intensity.

### BRIEF DESCRIPTION OF THE DRAWINGS

Various examples will be described below referring to the following figures:

FIG. 1 shows a display illuminated by light sources in accordance with various examples;

FIG. 2 shows a backlight system in accordance with various examples; and

FIG. 3 shows a method of controlling the light intensity of light sources in accordance with various examples.

### DETAILED DESCRIPTION

Local dimming may allow displays to achieve a greater contrast ratio between bright portions and dark portions of the display. Breaking the display into separate sections to be illuminated at different light intensities by distinct light sources allows one section to be brightly illuminated while another section is dimly illuminated. Using the light sources at different intensity levels may lead to uneven decay of the light sources, which may lead to uneven illumination levels if not corrected.

A decay curve may be generated that indicates how much a light source will decay with use over time. Usage data may be recorded for the light sources, allowing a controller to correct for decay of the light sources based on the decay curve.

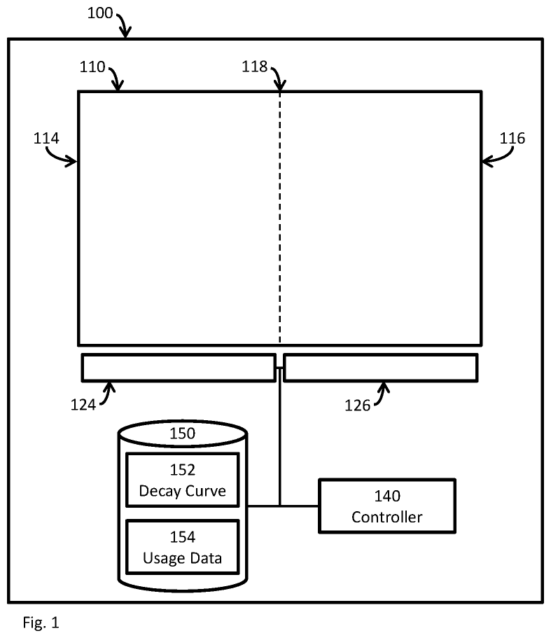

FIG. 1 shows a display 100 illuminated by light sources 124, 126 in accordance with various examples. Display 100 includes a light panel 110 divided into two sections 114, 116 at a dividing line 118. Display includes light sources 124, 126, a controller 140, and storage 150. Storage 150 includes a decay curve 152 and usage data 154.

Display 100 may include various displays illuminated via light sources. For example, display 100 may be a liquid crystal display illuminated by a backlight. The display 100 may be included in a television, monitor, cell phone, or other device. Display may implement local dimming. The first section 114 may be illuminated by the first light source 124. The second section 116 may be illuminated by the second light source 126. The first light source 124 and second light source 126 may be independently controllable. The first light source 124 and second light source 126 may be set to different light intensity levels at the same time. The first section 114 may be coupled to the first light source 124 along a side edge of the light panel 110. Light from the first light source 124 may pass through the first section 114 of the light panel 110 to be emitted out a face of the panel and through a liquid crystal display. The second section 116 may be coupled to the second light source 126.

In various examples, the first section 114 of the light panel 110 may be shaped or include deformities to emit a generally uniform light intensity from the face of the first section 114 with minimal light leakage into other sections, such as the second section 116. The dividing line 118 may define the sections in the light panel 110, such as the first light source 124 illuminates the first section 114 with minimal light leakage to the second section 116, and the second light source 126 illuminates the second section 116 with minimal light leakage to the first section 114.

In various examples, the light sources 124, 126 may comprise multiple light elements. The light elements may include light emitting diodes (LEDs), including organic LEDs; fluorescent lamps, including cold cathode fluorescent lamps, external electrode fluorescent lamps, hot cathode fluorescent lamps, and flat fluorescent lamps; electroluminescent (EL) light sources; or other light emitting devices. The light elements may emit a white light or other colored light. Light elements may individually emit a desired color or may be combined in the light source or in a section 114, 116 of the light panel 110 to emit a desired color. For example, LEDs of different colors may be used in the first light source 124 and their light combined in the light source or first section 124 to emit a white light from the face of the first section 114 of the light panel 110.

A controller 140 may control the light sources 124, 126. Control may include controlling a light intensity of the light sources 124, 126. The light sources may be controlled via a pulse-wave from a pulse-width modulator (PWM). The PWM may be part of the light sources 124, the controller 140, or exist as a distinct component. The light intensity of the light sources 124, 126 may be affected by the current, the voltage, and the duty cycle of the pulse-wave. In various examples, the current, voltage, and duty cycle of the pulse-wave may be varied, or one may be varied with the other two kept constant.

In various examples, the first light source 124 may be used independent of the second light source 126. For example, the display 100 may implement local dimming, causing the light sources 124, 126 to emit different light intensities at different times. As the light sources 124, 126 are used, they may decay. The decay may cause the light sources 124, 126 to emit lower light intensities at a set current, voltage, and duty cycle of a pulse wave than when the light sources were new. If the light sources 124, 126 are used differently over time, the light sources 124, 126 may decay by different amounts. For example, when manufactured, the light sources 124, 126 may emit the same intensity of light for a given current, voltage, and duty cycle of a pulse wave. After being used for ten years, the first light source 124 may emit 80% of its original light intensity, while the second light source 126 may emit 70% of its original light intensity, at that same current, voltage, and duty cycle. If left uncorrected, this may result in a visible difference in the brightness between different parts of the display 100. For example, when trying to display a uniform white image on the display 100, the part of the display 100 illuminated by the first light source 124 may be visibly brighter than the part of the display 100 illuminated by the second light source 126.

Controller 140 may correct for usage-based light intensity decay of the light sources 124, 126. Light sources 124, 126 may decay predictably over time with use. A decay curve 152 may be obtained that describes how the light sources 124, 126 decay. The decay maybe based on time and attributes of use, such as a current, voltage, and duty cycle of a pulse wave supplied to the light sources 124, 126. The decay curve 152 may be obtained as a specification from a manufacturer, through empirical testing, by calculations of theoretical performance, or by another appropriate method. The decay curve 152 for the light sources 124, 126 may be stored in storage 150 on the display. The decay curve 152 may take the form of a mathematical calculation, a look-up table, or another appropriate method to approximate the decay of the light sources 124, 126 based on usage. Usage data 154 of the light sources 124, 126 may be stored in storage 150 and used to calculate the decay of the light sources 124, 126. The usage data 154 may be updated as the light sources 124, 126 are used.

In various examples, controller 140 may receive data to set the light sources 124, 126 to certain light intensities. The received data may include a video signal encoding a video to be displayed on the display 100. The video signal may indicate the light sources 124, 126 are to be set to different light intensities. Based on the usage data and the decay curve 152, controller 140 may calculate the decay of the light sources 124, 126 and accordingly modify the PWM settings in controlling the light sources 124, 126. In practice, the controller 140 may be distributed across multiple components or implemented in one component, such as a microprocessor. For example, one component may calculate the desired light intensity based on a video signal, another component may calculate a decay of the light sources, another component may calculate the PWM settings for the desired light intensity, and another component may calculate how to modify the PWM settings based on the decay.

In various examples, the video signal may indicate an overall image to display on the display 100. The first section 114 of the light panel 110 may correspond to a first section of the display 100, and a second section 116 of the light panel 110 may correspond to a second section of the display 100. The overall image may indicate a first image to be displayed on the first section of the display 100, and a second image to be displayed on the second section of the display 100. The first image may be brighter than the second image, which may cause the controller 140 to control the first light source 124 to emit a higher light intensity than the second light source 126.

In various examples, the light panel 110 and light sources 124, 126 may be part of a backlight. The display 100 may include a reflective surface across a back face and sides of the light panel 110 to reflect light out a front face of the light panel. The display 100 may include a diffuser, polarizer, and other components to help direct light from the light sources 124, 126 through the display 100.

In various examples, usage data 154 may include the settings of the PWM for the light sources 124, 126 and the duration of time until the settings changed. If the current and voltage are kept the same while in use, the PWM settings recorded in the usage data 154 may include just the duty cycle or any other settings that change.

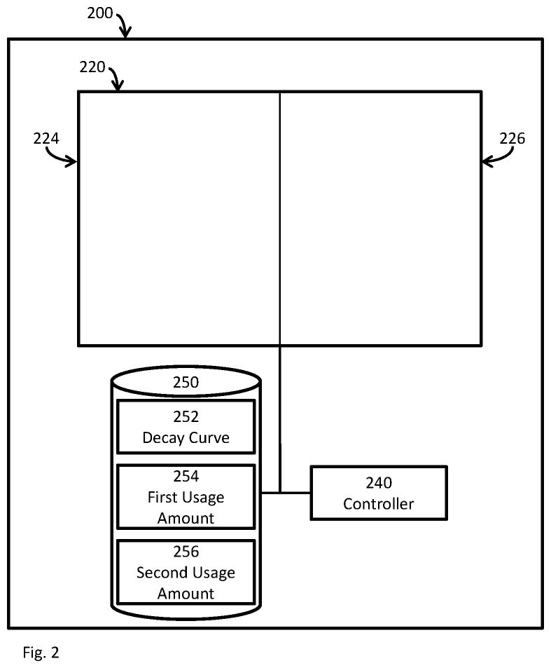

FIG. 2 shows a backlight system 200 in accordance with various examples. Backlight system 200 includes a backlight 220 composed of two light sources 224, 226, storage 250, and a controller 240. Storage 250 includes a decay curve 252, a first usage amount 254, and a second usage amount 256. The backlight system 200 may be used in connection with a display, such as a liquid crystal display.

In various examples, light sources 224, 226 may be arranged to be behind a display. Reflective cavities and diffusion films may assist in providing a uniform light emission from the light sources 224, 226. Color-correction films may also be used.

In various examples, the first usage amount 254 of the first light source 224 may be stored separately than the second usage amount 256 of the second light source. The separation may be into separate files or separate storage devices. For example, the backlight system 200 may include separate controllers 240 and separate storage 250 for the light sources 224, 226.

In various examples, the controller 240 updates the first usage amount 254 based on the controller's 240 control of the first light source 224 and updates the second usage amount 256 based on the controller's control of the second light source 226.

In various examples, a zone includes a region of the display to be illuminated by the backlight with approximately the same light intensity. For example, a zone may include a vertical or horizontal strip of the display. A display may be divided into zones both horizontally and vertically, such as in a checkerboard pattern. The display may include any number of zones. The first light source 224 may correspond to a first zone of the backlight 220. The second light source 226 may correspond to a second zone of the backlight 220. A zone may have any number of corresponding light sources. The zones may be used in implementing local dimming. For example, a video signal may indicate that the first zone of the backlight 220 is to have a higher brightness than the second zone. In response, the controller may control the first light source 224 to have a higher light intensity than the second light source 226. Due to decay of the light sources 224, 226, control of the light sources 224, 226 may include setting the current, voltage, or duty cycle of the second light source 226 to be higher than the settings for the first light source 224.

In various examples, the first usage amount 254 may be in various formats. For example, the first usage amount 254 may include a history of the use of the first light source 224 since manufacture. Due to the amount of data involved, the first usage amount 254 may be aggregated at different points in time. For example, the first usage amount 254 may include a summed usage amount and an incremental usage amount to represent the overall usage amount. As the first light source 224 is used, data regarding the PWM settings and duration of time may be stored as an incremental usage amount. The incremental usage amount may be in the form of a data log over time, for example, one set of PWM settings for 10 milliseconds, another set of PWM settings for 50 milliseconds, and so on to detail use of the first light source 224 since a last summation. At various points in time, the incremental usage amount may be combined together and included in the summed usage amount. This combining into a summed usage amount may take place when the display is turned off, or after a certain duration of time, such as after 3 months since the last combining, or after a certain duration of usage, such as 100 operating hours. The controller 240 may calculate the decay based on the summed usage amount, disregarding the incremental usage amount. This may make calculation of the decay easier. The summed usage amount may be stored in the form of a decay amount, such as a percentage, used by the controller 240. Use of the summed usage amount may be appropriate where the decay is gradual over time or repeated calculation of the decay during operation of the backlight system 200 is computationally intense. In various examples, the controller 240 may use the summed usage amount and the incremental usage amount in determining the decay for control of the first light source 224. Use of a summed usage amount may lessen the amount of storage space used to store the first usage amount 254.

In various examples, the first usage amount 254 may include data regarding an output signal of a PWM. The PWM may be used in controlling the first light source 224. The data may include a duty cycle, peak voltage value, or current of a pulse wave generated by the PWM.

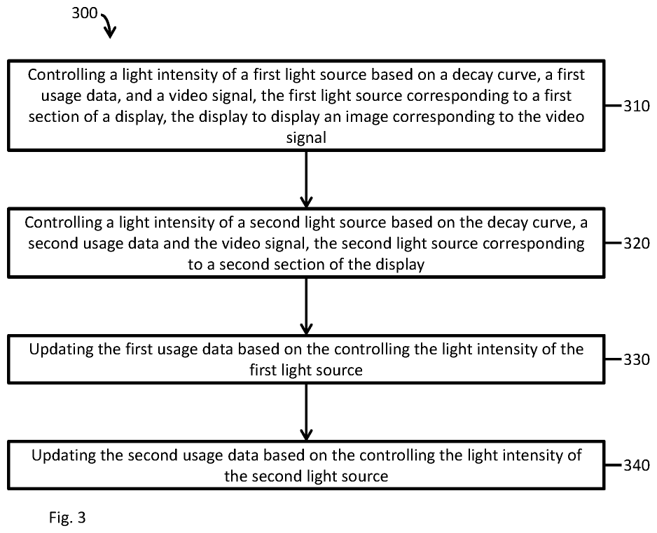

FIG. 3 shows a method 300 of controlling the light intensity of light sources in accordance with various examples. Method 300 includes controlling a light intensity of a first light source based on a decay curve, a first usage data, and a video signal, the first light source corresponding to a first section of a display, the display to display an image corresponding to the video signal (310). Method 300 includes controlling a light intensity of a second light source based on the decay curve, a second usage data and the video signal, the second light source corresponding to a second section of the display (320). Method 300 includes updating the first usage data based on the controlling the light intensity of the first light source (330). Method 300 includes updating the second usage data based on the controlling the light intensity of the second light source (340).

In various examples, the light sources may decay enough to affect the overall brightness to be displayed. For example, the display may be designed so that the maximum light intensity of a light source is not used during normal operations. Instead, the maximum used light intensity may be 80% of the light source's original capability. This may allow some decay of the light source before operation of the display is materially affected. If one of the light sources decays 21%, so that it is reduced to 79% of its original capability, the overall brightness of the display may be reduced to account for the decay. Thus, if a video calls for displaying the brightest white possible, both light sources may be set to a light intensity of 79% of their original capability, even though one light source may still be able to emit 80% of its original capability.

In various examples, control of a light source may include controlling the light source to be off. This may be used when a video signal indicates a portion of the display should be black. One light source may thus be controlled to be turned off while another light source is controlled to be turned on, based on the video signal.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An apparatus comprising:
a first light source to illuminate a display;
a second light source to illuminate the display;
a storage to store data regarding a decay curve of the first light source and the second light source and to store usage data regarding a use of the first light source and a use of the second light source; and
a controller to control a first light intensity of the first light source and to control a second light intensity of the second light source, wherein the control is based on a video signal of a video to be displayed on the display, the decay curve, and the usage data.

2. The apparatus of claim 1, wherein the first light source is to illuminate a first section of the display, the second light source is to illuminate a second section of the display, a first image is to be displayed on the first section of the display based on the video signal, a second image is to be displayed on the second section of the display based on the video signal, and the first light intensity is higher than the second light intensity based on a brightness of the first image being higher than a brightness of the second image.

3. The apparatus of claim 1, comprising a backlight, wherein the backlight comprises the first light source and the second light source.

4. The apparatus of claim 3, wherein the backlight includes a light guide panel, and the first light source and the second light source are oriented along a side edge of the light guide panel.

5. The apparatus of claim 1, comprising a pulse-width modulator coupled to the first light source to generate a pulse wave, wherein the usage data is based on a duty cycle of the pulse wave and an amount of time.

6. An apparatus comprising:
a backlight comprising:
a first light source; and
a second light source;
a controller coupled to the backlight to control a first light intensity of the first light source and to control a second light intensity of the second light source; and
a storage coupled to the controller, wherein the storage is to store a decay curve for the first light source and the second light source, a first usage amount of the first light source, and a second usage amount of the second light source, the controller is to control the first light intensity based on the decay curve and the first usage amount, the controller is to control the second light intensity based on the decay curve and the second usage amount, the controller is to update the first usage amount based on the control of the first light intensity, and the controller is to update the second usage amount based on the control of the second light intensity.

7. The apparatus of claim 6, wherein the first light source corresponds to a first zone of the backlight, the second light source corresponds to a second zone of the backlight, the controller is to receive a signal indicating a first target light intensity of the first zone and a second target light intensity of the second zone, the first target light intensity being greater than the second target light intensity, and the controller is to control the first light intensity to be greater than the second light intensity in response to receipt of the signal.

8. The apparatus of claim 6, wherein the first usage amount includes a summed usage amount and an incremental usage amount, wherein, after a duration of time, the summed usage amount is to be incremented by the incremental usage amount.

9. The apparatus of claim 6, comprising a pulse-width modulator coupled to the controller and the first light source, the controller to control the first light intensity via the pulse-width modulator.

10. The apparatus of claim 9, wherein the first usage amount includes data regarding an output signal of the pulse-width modulator to the first light source.

11. A method comprising:
controlling a light intensity of a first light source based on a decay curve, a first usage data, and a video signal, the first light source corresponding to a first section of a display, the display to display an image corresponding to the video signal;
controlling a light intensity of a second light source based on the decay curve, a second usage data and the video signal, the second light source corresponding to a second section of the display;
updating the first usage data based on the controlling the light intensity of the first light source; and
updating the second usage data based on the controlling the light intensity of the second light source.

12. The method of claim 11, comprising:
determining that a decay of the first light source is greater than a decay threshold based on the decay curve and the second usage data; and
adjusting the controlling of the light intensity of the second light source to a lower light intensity in response to the determination.

13. The method of claim 11, comprising calculating the first usage data based on a current signal supplied to the first light source and a voltage signal supplied to the first light source.

14. The method of claim 11, wherein the voltage signal comprises a pulse wave.

15. The method of claim 11, wherein controlling the light intensity of the first light source causes the first light source to be off, based on the video signal, at the same time that controlling the light intensity of the second light source causes the second light source to be on, based on the video signal.
